(19) United States
(12) Patent Application Publication
(10) Pub. No.: US 2008/0199820 A1
(43) Pub. Date: Aug. 21, 2008

(54) Support Assembly For Supporting Heat Regeneration Checker Work In A Hot Blast Stove, Hot Blast Stove Provided With Said Support Assembly, Method Of Producing Hot Air Using Said Hot Blast Stove

(75) Inventors: Tom Cellissen, Amsterdam (NL); Edwin Martijn Van Den Haak, Beverwijk (NL); Reinoud Jacobus Van Laar, Haarlem (NL)

Correspondence Address: STEVENS DAVIS LLP, 1615 L STREET NW, SUITE 850, WASHINGTON, DC, 20036, US

(73) Assignee: Danieli Corus BV, Ijmuiden (NL)

(21) Appl. No.: 11/815,079

(22) PCT Filed: Jan. 30, 2006
(86) PCT No.: PCT/EP06/00917

§ 371 Date: Apr. 12, 2008

(30) Foreign Application Priority Data
Feb. 1, 2005 (EP) 05075243.5

(51) Int. Cl. F27D 5/00; C21B 3/00; C21B 9/08

(52) U.S. Cl. 432/28; 266/274; 266/139

(57) ABSTRACT

Support assembly for supporting heat regeneration checker work in a hot blast stove for a blast furnace. The assembly includes a supporting grid for supporting the checker work, and supporting columns for supporting the supporting grid. The assembly includes a cast iron material. The cast iron material includes a ferritic matrix and a dispersion of graphite particles wherein the shape of the graphite particles is substantially vermicular or nodular.

This invention relates to a support assembly for supporting heat regeneration checker work in a hot blast stove for a blast furnace. The invention also relates to a hot blast stove provided with said support assembly and to a method of producing hot air using said hot blast stove.

For the production of iron in a blast furnace, large quantities of hot air, also known as hot blast, are required. Cold air is preheated in large thermal regenerators called hot blast stoves and is injected as hot blast air into the lower part of the blast furnace. Each blast furnace is typically provided with three hot blast stoves, although alternative arrangements are possible.

Each hot blast stove is a large regenerative heat exchanger, a typical example having a cylindrical shape topped with a dome, comprising a burner part and a regenerative heat exchanging part, usually consisting of a refractory checker work. The shell is a welded steel cylinder, typically 6 to 10 meters in diameter and 30 to 50 meters high. The shell is designed to withstand the operating blast pressure. The shell is insulated to minimize heat losses and to prevent structural damage to the shell caused by high thermal stresses.

The operational cycle of such a hot blast stove substantially comprises two phases: ‘on gas’ and ‘on air’. When ‘on gas’, combustible gas and combustion air are mixed and burned in the burner part of the stove and the hot flue gas is used to heat the checker work by leading the hot flue gas top-down through the checker work. The temperatures at the top of the checker work, the dome temperature, may be about 1400° C. The temperature of the hot flue gas decreases on its way down towards the bottom part of the checker work. The bottom part of the checker work rests on a support assembly, usually comprising a supporting grid consisting substantially of a grey cast iron grid which is strengthened by girders, supported by grey cast iron columns. A cavity is thus obtained under the checker work. This cavity is typically about 2 to 4 m in height in conventional stoves. At the location of the support assembly the maximum temperature of the hot flue gas, the maximum exhaust temperature, is limited by the hot strength of the grey cast iron and is usually limited to about 450° C.

When this maximum exhaust temperature is reached at the location of the support assembly, the hot blast stove is put ‘on air’, which means that combustion and hence the flow of flue gas is stopped Cold blast air is now introduced into the hot blast stove through the cavity under the checker work and led upwardly through the hot checker work to be heated turning the cold blast air into hot blast air which is subsequently fed to the blast furnace. A quantity of cold blast air is also bypassed around the stove and is introduced into the hot blast air prior to entering the blast furnace by means of a mixer valve. This blending or mixing of hot blast air and cold blast air ensures that a constant hot blast air temperature is maintained prior to introduction into the blast furnace. The mixer valve is in an open position at the start of the ‘on air’ phase and is closed progressively until the hot blast air leaving the stove is equal in temperature to the desired hot blast air temperature. A decrease of the outlet temperature of the hot blast air below a temperature threshold of about 1250° C. dictates changing to another stove. The hot blast stove is then again put ‘on gas’. During normal operation of a blast furnace three stoves are used, such that one stove is always ‘on air’, while the other two stoves are ‘on gas’. However, it should be noted that, depending on the lay-out of the iron production works and the type and design of the hot blast stove, the number of stoves may also be more or less than three. It is not uncommon for example to use 2 or 4 stoves per blast furnace, or 5 stoves per two blast furnaces.

The combustible gas comprises blast furnace gas which is enriched by either natural gas or coke oven gas. The caloric value of blast furnace gas is not sufficient to reach the required maximum temperature of about 1400° C. at the top of the checker work. This enrichment of the combustible gas is costly.

In an integrated steelworks, the hot blast stoves account for 10 to 15% of the total energy requirement. Therefore, there is a continuous strive towards a more efficient hot blast stove. It is known that the efficiency of a hot blast stove system can be improved by increasing the maximum exhaust temperature which is currently about 450° C.

EP 0 892 078-B1 discloses a supporting grid for a hot blast stove which comprises a lamellar graphite structure and a pearlitic-ledeburic matrix.

It is an object of the invention to provide a support assembly for supporting heat regeneration checker work in a hot blast stove which allows an increase of the maximum exhaust temperature of the hot flue gases.

It is also an object of the invention to provide a support assembly for supporting heat regeneration checker work in a hot blast stove enabling to use blast furnace gas as its sole source of combustible gas.

It is also an object of the invention to provide a support assembly for supporting heat regeneration checker work in a hot blast stove enabling to construct a more compact hot blast stove by reducing the amount of checker work required and hence reducing the capital expenses.

One or more of these objects and additional advantages are reached by a support assembly for supporting heat regeneration checker work in a hot blast stove for a blast furnace, the assembly comprising a supporting grid for supporting the checker work, and supporting columns for supporting the supporting grid, the assembly comprising a cast iron material, the cast iron material comprising a ferritic matrix and a dispersion of graphite particles wherein the shape of the graphite particles is substantially vermicular or nodular.

The temperature resistance of cast iron material comprising a ferritic matrix and a dispersion of graphite particles wherein the shape of the graphite particles is substantially vermicular or nodular, denoted by vermicular cast iron or nodular cast iron, is better than that of grey cast iron, grey cast iron also being known as lamellar cast iron according to the shape of the lamellar graphite particles in the iron matrix. It is noted that the phrase ‘substantially’ is used to indicate that the intention of the invention is that 100% of the graphite particles have a vermicular or nodular shape. It is also noted that a ferritic matrix is to be distinguished from a ferritic-perlitic matrix. In the context of this invention, a ferritic matrix is to be understood as to comprise substantially no pearlite. It is noted that the phrase ‘substantially’ is used to indicate that the intention of the invention is that the ferritic matrix consists only of a ferritic structure and therefore comprises no pearlite. The object of the invention can therefore also be reached by a support assembly for supporting heat regeneration checker work in a hot blast stove for a blast furnace, the assembly comprising a supporting grid for supporting the checker work, and supporting columns for supporting the supporting grid, the assembly comprising a cast iron material, the cast iron material comprising a completely ferritic matrix and a dispersion of graphite particles wherein the shape of the graphite particles is vermicular or nodular.

This vermicular or nodular cast iron retains its strength or at least a substantial part of its room temperature strength up to temperatures of at least 600° C. By constructing the support assembly for supporting heat regeneration checker work in a hot blast stove substantially; or even entirely, of vermicular or nodular cast iron, the exhaust temperature of the hot flue gases at the location of the support assembly can be substantially (i.e. significantly) higher than 450° C. Since the vermicular or nodular cast iron retains its strength at these elevated temperatures, the checker work is stably supported. If so desired, some parts of the support assembly may be produced from vermicular cast iron and other parts may be produced from nodular cast iron. It is important that the matrix of the cast iron material is ferritic, and that the strength of the cast iron is not provided by pearlitic or bainitic phases. A ferritic matrix is stable up to the Ac1 temperature when the matrix starts to transform to austenite. Known types of cast iron obtaining their strength from a pearlitic, ferritic-bainitic or bainitic matrix undergo a phase transformation at temperatures at or below Ac1 when the non-equilibrium bainitic phase is tempered or transformed to a phase having a significantly lower hot strength, or when the equilibrium pearlite phase transforms into austenite. These phase transformations or tempering reactions render the types of cast irons steels which obtain their strength from a pearlitic, ferritic-bainitic or bainitic matrix unsuitable for the application in a support assembly for application at substantially (i.e. significantly) elevated exhaust temperatures of the hot flue gases. It should be noted that the supporting grid is usually strengthened by girders. For the sake of this invention) these girders are considered to be a part of the supporting grid. Moreover, a presence of lamellar graphite causes the cast iron to be more susceptible to fatigue, which may be an issue as a result of the many changes in temperature during its lifetime, particularly in a bending mode of loading or a tensile mode of loading, and also to cracking, since the lamellar graphite is known to be able to work as a crack initiator.

An advantage of the higher exhaust temperature of the hot flue gases is that the remaining heat or sensible heat in the flue gases which may be used to preheat the combustion air and/or the combustible gas increases. As a result of this preheating, the combustible mixture is already at an elevated temperature prior to combustion. The temperature difference between the dome temperature and the temperature of the combustible mixture is thereby reduced, thereby also reducing the amount of additional heat that has to be added to attain the desired dome temperature of about 1400° C. In a conventional hot blast stove, the combustible gas, which is usually blast furnace gas, has to be enriched with gases of a higher caloric value, such as natural gas or coke gas. By preheating the combustible mixture, the degree of enrichment can be reduced. It has been found by the inventors that the degree of enrichment can be reduced or even eliminated if an maximum exhaust temperature of about 600° C. is obtained and the remaining heat in the exhaust gases is used to preheat the combustible mixture by preheating the combustion air and/or the combustible gas, for instance in a known type of heat exchanging unit. The hot blast stove can now be operated to a significantly larger extent or even solely on blast furnace gas, thereby significantly reducing the operational costs of the process since less or no enrichment of the combustible gas is needed.

The height of the checker work of a hot blast stove is determined partly by its thermal capacity. The amount of heat stored in the checker work has to be sufficient to supply the blast furnace, together with the other hot blast stoves, with a continuous supply of hot blast air. The amount of checker work represents a significant cost factor during the construction or revamp of a hot blast stove. The height of the checker work is also determined partly by the temperature gradient from the top of the checker work to the support assembly. Given a certain amount of checker work, the heating of the hot blast stove has to be stopped once the exhaust gas temperature reaches the maximum operational temperature of the support assembly. By increasing the allowable maximum operational temperature of the support assembly, the amount of checker work can be chosen smaller. For instance with a dome temperature of 1400° C. and using a maximum exhaust temperature of 600° C. the amount of checker work in this respect can be reduced by at least 15% in comparison to using a maximum exhaust temperature of 450° C. Of course it depends on the thermal capacity of the remaining checker work whether this is actually possible whilst maintaining the stove regime, for example the three-stove or four-stove regime. Any reduction in amount of checker work leads to a reduction in the capital expenses during construction or revamp of the stove. When designing and constructing a new stove, the design could also be made more compact using the support assembly according to the invention. It should be noted that the invention also relates to other designs of hot blast stoves such as the so-called external shaft burner design, and the dome burner design.

In an embodiment of the invention the supporting columns, and/or the supporting grid consists substantially of said cast iron material, and preferably entirely of said cast iron material. Consequently, in this embodiment the support assembly or the supporting columns and/or the supporting grid is produced substantially entirely or entirely from the cast iron material according to the invention thus allowing the maximum exhaust temperature to be increased. In case the supporting grid or the supporting columns are made from another material, it is clear that this other material has to be capable of withstanding the local operational conditions in the hot blast stove.

In an embodiment of the invention the ratio between the length and the width of the graphite particles is substantially lower than 20, preferably lower than 10. The phrase substantially is used to indicate that the intention of the invention is that the ratio is lower than 20, and preferably lower than 10, for all graphite particles. The smaller the ratio, the smaller the brittleness of the cast iron material, because the graphite particles work less as a stress enhancer with decreasing ratio between the length and the width of the graphite particles. It should be noted that the length and the width and the length of a graphite particle is defined as the maximum length of such a particle in cross section, and that the width is the maximum width of such a particle in cross section, wherein the length and the width are measured essentially perpendicularly. In this embodiment, the graphite particles are elongate when seen in cross section.

In an embodiment of the invention the cast iron material comprises (in weight percent)
2.0 to 3.8% carbon;
1.8 to 5.0% silicon;
0.1 to 1.0% manganese;
up to 0.1% phosphor;
up to 0.1% sulphur;
optionally up to 1.25% molybdenum;
unavoidable impurities, balance iron.

The inventors found that when using a cast iron material having a ferritic matrix and a graphite dispersion wherein the shape of the graphite is substantially vermicular or nodular, or even entirely vermicular or nodular can be produced with this composition which retains its hot strength allowing a substantial (i.e. significant) increase of the maximum exhaust temperature. It is clear that the cast iron material also comprises small amounts of additions to promote the shape of the graphite to become vermicular or nodular, also known as inoculation agents or agents for nodulising or compacting graphite segregation. Examples of these graphite morphology influencing agents are magnesium, silicon, titanium, aluminium, and rare earth metals.

In an embodiment of the invention the cast iron material comprising a ferritic matrix and a graphite dispersion wherein the shape of the graphite is substantially vermicular, or even entirely vermicular, wherein the ratio between the length and the width of the graphite particles is lower than 20, preferably lower than 10, more preferably lower than 8, wherein the cast iron material comprises (in weight percent):
2.0 to 3.8% carbon;
1.8 to 5.0% silicon;
0.1 to 1.0% manganese;
up to 0.1% phosphor;
up to 0.1% sulphur;
optionally up to 1.25% molybdenum,
unavoidable impurities, balance iron.

In this embodiment the amount of graphite morphology influencing agent or agents and the time of dosage of these agent or agents is chosen so as to obtain the desired graphite segregation dispersion and shape.

In an embodiment of the invention the cast iron material comprising a ferritic matrix and a graphite dispersion wherein the shape of the graphite is substantially nodular, or even entirely nodular, wherein the ratio between the length and the width of the graphite particles is substantially lower than 5, preferably lower than 2, more preferably about 1, wherein the cast iron material comprises (in weight percent):
2.0 to 3.8% carbon;
1.8 to 5.0% silicon;
0.1 to 1.0% manganese;
up to 0.1% phosphor;
up to 0.1% sulphur;
optionally up to 1.25% molybdenum;
unavoidable impurities, balance iron.

It was found by the inventors that the cast iron material having a graphite dispersion consisting substantially, or even entirely, of graphite particles having a ratio between the length and the width of the graphite particles of lower than 5, preferably of lower than 2, more preferably of about 1 retain their hot strength up to a high temperature. A ratio of 1 means that the nodules are circular in shape. In combination with the stable ferritic matrix this material allows for a significant increase in maximum exhaust temperature.

In an embodiment of the invention the cast iron material comprises molybdenum between 0.1 and 1.25%, preferably between 0.1 and 1.0%, more preferably between 0.3 and 0.9%.

The addition of molybdenum results in an increase of the tensile strength of the cast iron material. The maximum level of the molybdenum addition is given by the formation of excess carbides which are detrimental to the toughness of the material.

In an embodiment of the invention the cast iron material comprises silicon between 3.8 and 5.0, preferably between 4.0 and 4.8%, more preferably between 4.3 and 4.8%.

The addition of silicon to the cast iron material promotes the stability of the ferritic matrix. Adding silicon shifts the phase transformation temperature Ac1 to higher temperatures, thereby increasing the stable temperature range of the ferritic matrix and also increasing the useful range of the cast iron material in a support assembly according to the invention. The addition of the silicon also has a beneficial influence on the hot strength of the ferritic matrix, thus increasing the hot strength. The toughness decreases with increasing silicon addition, and the inventors found that the maximum silicon amount is 5.0%, preferably 4.8%.

In an embodiment of the invention the cast iron material comprises silicon between 1.8 and 3.0, preferably between 2.0 and 2.9%, more preferably between 2.3 and 2.9%. It was found that especially the cast iron material comprising molybdenum between 0.1 and 1.25%, preferably between 0.1 and 1.0%, more preferably between 0.3 and 0.9% in combination with the silicon ranges of between 1.8 and 3.0, preferably between 2.0 and 2.9%, more preferably between 2.3 and 2.9% provides good hot strength in combination with low alloying costs.

In an embodiment of the invention the cast iron material comprises carbon between 2.3 and 3.8, preferably between 2.3 and 3.6%, more preferably between 2.4 and 3.3%. These ranges were found to be a good compromise between the prevention of forming large amounts of carbide, which adversely affect the toughness, (thermal) fatigue, castability and shrinkage during solidification and the presence of sufficient amount of carbon for the formation of the desired graphite dispersion and graphite shape.

In an embodiment of the invention the cast iron material comprises manganese lower than 0.5%, preferably lower than 0.3%, more preferably 0.2% or lower.

Manganese reduces the Ac1-temperature and promotes the formation of pearlite. For the matrix of the cast-iron material to be ferritic, the maximum allowable amount of manganese was found to be lower than 0.5%, preferably lower than 0.3%, more preferably 0.2% or lower.

According to a second aspect, a regenerative heat generator, such as a hot-blast stove for a blast furnace, is provided, which generator comprises a combustion chamber and a heat-regeneration shaft filled with heat regeneration checker work, the combustion chamber and the heat regeneration shaft being separated by a wall, and a burner being located at the bottom of the combustion chamber, a connection port for supplying combustion air and a connection port for supplying a combustible gas, a discharge port for discharging the flue gas, a cold blast inlet port for supplying cold blast air to be converted into hot blast air and a discharge port for discharging the hot blast air, the checker work in the heat regeneration shaft being supported by a support assembly comprising a supporting grid and supporting columns, wherein the support assembly is provided as described above. The invention relates to any kind of hot blast stove design such as dome burner designs, external shaft designs and the design described in detail below.

With said regenerative heat generator, the maximum exhaust temperature can be significantly increased because of the hot strength of the cast iron material in the support assembly. An exhaust temperature exceeding 600° C. or even higher such as 625, 650 or 700° C. may be used allowing a lower degree or no enrichment of the blast furnace gas as combustion gas, and/or allowing a reduction in the amount of checker work in the regenerative heat generator. It should be noted that the limit to increasing the exhaust temperature is given by the hot strength of the support assembly and by the degree of thermal shock the assembly and the checker work can endure since during each reversal of ‘on gas’ to ‘on air’ the assembly and the checker work is subjected to a thermal shock, the magnitude of which increases with increasing exhaust temperature, since the temperature of the cold air entering the regenerative heat generator during the ‘on air’ phase is substantially constant at about 180° C. due to the adiabatic compression of ambient air.

The invention is also embodied in a method of producing hot blast air for a blast furnace using a hot blast stove, which stove is provided with a support assembly as described above for supporting the checker work in the heat regeneration shaft. This allows a higher maximum exhaust temperature and thus the production of hot blast air with a lower degree or no enrichment of the blast furnace gas as combustion gas by using the remaining heat still present in the flue gases after having exited the hot blast stove through the discharge port for discharging the flue gas, to preheat the combustion air and/or the combustible gas prior to combustion in the combustion chamber of the stove. The production of hot blast air may thus be performed using a lower degree of enrichment of the blast furnace gas or using blast furnace gas only, thereby achieving a significant cost reduction and reduction of Consumption of enrichment gas. In an embodiment of the invention the combustible mixture is preheated using the remaining heat in the flue gases after having exited the hot blast stove through the discharge port for discharging the flue gas to a temperature of at least 150° C., preferably at least 200° C., more preferably at least 250° C. It was found that for a given hot blast stove for a combustible mixture having a caloric value of about 3300 kJ/Nm³ a preheat temperature of the combustible mixture of about 280° C. required no enrichment to obtain a dome temperature of 1400° C., and that for a combustible mixture having a caloric value of about 3650 kJ/Nm³ a preheat temperature of the combustible mixture of about 200° C. is sufficient.

According to another aspect there is provided a method of producing hot blast air for a blast furnace using a hot blast stove system comprising a regenerative heat generator for providing hot blast air, and a preheating device, such as a heat exchanger, the method comprising preheating the combustion air and/or the combustible gas using the sensible heat of the flue gases after having exited the hot blast stove through the discharge port for discharging the flue gas prior to combustion in the combustion chamber of the regenerative heat generator, preferably wherein the exhaust temperature of the flue gas is at least 500° C.

So to minimize the costs of enrichment, recovery of waste heat from the regenerative heat exchanger can be applied. The design waste gas temperature of modern regenerative heat exchangers is approximately 400°-450C. In that case, the efficiency of the system as a whole is typically around 80%. The heat of the flue gas can be recovered and used for preheating of the combustible gas and/or combustion air for the regenerative heat exchangers. In addition to the reduction in consumption of expensive enrichment gas, the application of a preheating device or a waste heat recovery unit will increase the overall system efficiency by up to 8%. The preheating device unit would preferably reduce the final waste gas temperature exiting the preheating device to levels just above the acid dew point of the waste gas mixture, which is about 130° C., to avoid condensation in the preheating device or in chimney system following the preheating device.

More preferably the exhaust temperature exceeds 600° C. or even higher such as 625, 650 or 700° C. The higher the exhaust temperature of the flue gases, the higher the temperature of the gases entering the preheating device. In order to allow these high exhaust temperatures, the hot blast stove is equipped with a support assembly as described above or with another support assembly allowing the levels of exhaust temperatures of 500, 600, 625, 650 or even 700° C. The invention is therefore also embodied in a method of producing hot blast air for a blast furnace using a hot blast stove, which stove is provided with a support assembly for supporting the checker work in the heat regeneration shaft allowing a maximum flue gas temperature at the location of the support assembly or maximum exhaust temperature of 500° C. or higher, preferably of 600 or higher, more preferably 625 or higher, even more preferably 650 or higher or even 700° C. or higher.

The invention will now be explained in more detail below with reference to the following materials, of which the composition is given in Table 1.

TABLE 1
Cast iron materials for support assembly according to
the invention in preferred embodiment having a
microstructure according to the invention.

| Material | C | Si | Mn | P | S | Cr | Cu | Mo | Ni |
|---|---|---|---|---|---|---|---|---|---|
| Lamellar | 3.0 | 2.5 | 0.7 | 0.06 | 0.05 | 0.42 | n.d. | 0.40 | n.d. |
| Base | 3.1 | 2.6 | 0.2 | 0.05 | 0.01 | 0.03 | 0.04 | <0.01 | 0.02 |
| Mo | 3.0 | 2.5 | 0.2 | 0.07 | 0.01 | 0.03 | 0.04 | 0.39 | 0.02 |
| MoSi | 2.6 | 4.5 | 0.2 | 0.05 | 0.01 | 0.03 | 0.01 | 0.83 | 0.02 |

Samples from the materials in Table 1 were prepared and exposed to high temperature testing. These tests reveal that a given design tensile strength for the conventionally used lamellar material (“Lamellar” in Table 1, n.d.=not determined) is reached at a temperature of about 400° C. The same design strength is reached for the materials of Table 1 at a temperature of about 530° C. for the Base material and about 610° C. for the Mo and MoSi material. When the yield strength is considered, the MoSi outperforms the Mo material with about 20° C., resulting, in the design yield strength at about 630° C.

The invention will now be further explained with reference to the following figures, in which:

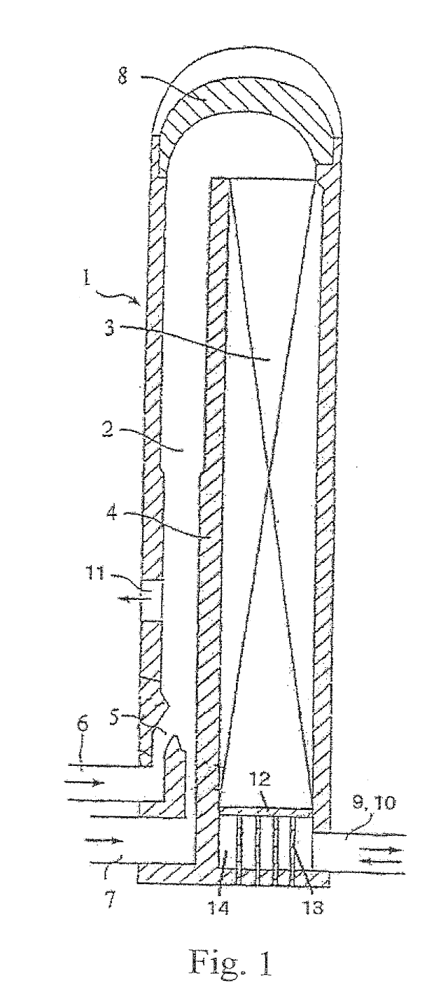

FIG. 1 schematically shows, as an example of a regenerative heat generator, a known design of hot-blast stove for a blast furnace;

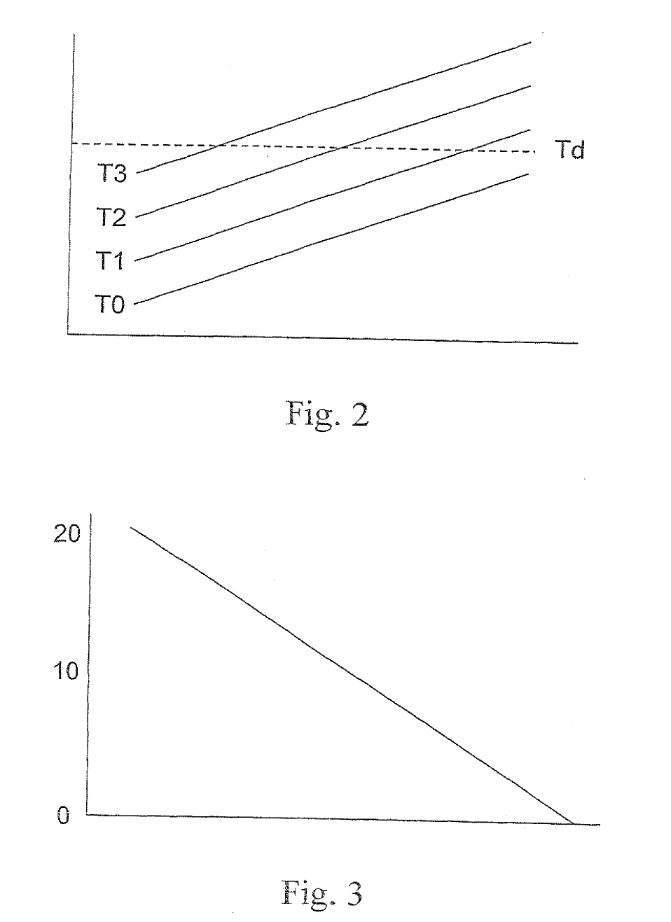

FIG. 2 shows a schematic representation of the relation between the dome temperature and the caloric value of the gas required for different degrees of preheating the combustion air/and or combustible gas;

FIG. 3 shows a schematic representation of the relation between the preheat temperature and amount of enrichment required for a combustible gas of a given caloric value;

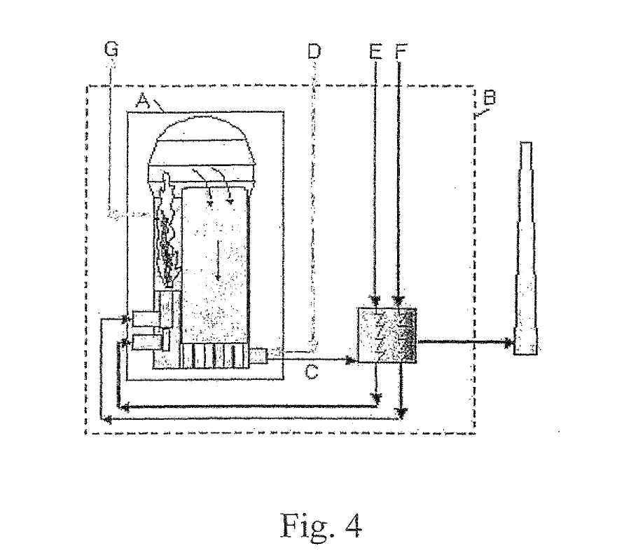

FIG. 4 schematically illustrates the definitions of regenerative heat exchanger efficiency and system efficiency.

In FIG. 1, reference number 1 denotes a heat generator in the form of a hot-blast stove for a blast furnace, The hot-blast stove comprises a combustion chamber 2 and a heat-regeneration shaft 3 filled with heat regeneration checker work, the combustion chamber and the heat regeneration shaft being separated from one another by a wall 4. A burner, usually a ceramic burner, 5 is located at the bottom of the combustion chamber. Combustion air for the ceramic burner is supplied through connection port 6, and fuel in the form of a combustible gas is supplied through connection port 7. The mixture of combustion air and combustible gas is burned in combustion chamber 2. The hot flue gases resulting from the combustion rise upwardly in the combustion chamber 2, are diverted via the cupola 8, and then pass through the heat-regeneration shaft 3 which is filled with heat regeneration checker work (not shown), during which passage the hot flue gas heats up the checker work. The flue gases cool as a result of this action and leave the hot-blast stove through the discharge ports 9, one of which is illustrated.

After the heat regeneration checker work has been heated to a sufficiently high temperature, the supply of fuel and combustion air through the ports 6 and 7 is discontinued, after which cold blast air is supplied into the hot blast stove through the cold blast inlet port 10. This cold blast air then flows through the hot checker work in the heat regeneration shaft 3, is heated therein, and then leaves the hot-blast stove via port 10. Port 11 is connected to a distribution system for hot air, the so-called hot blast, in order for it to be fed to the blast furnace. The checker work in the heat regeneration shaft 3 is supported by a supporting grid 12, which is supported by supporting columns 13. A cavity 14 is created under the checker work so as to enable to remove the hot flue gases evenly and introduce the cold blast air evenly distributed through the checker work.

In FIG. 2 a schematic representation of the relation between the dome temperature and the caloric value of the gas required for different degrees of preheating the combustion air/and or combustible gas is shown. It will be clear that the higher the preheat temperature (T3>T2>T1>T0, wherein T0 denotes no preheat) for a combustible mixture of a given caloric value, the higher the obtainable dome temperature. The desired dome temperature is indicated with Td. On the vertical axis the dome temperature is shown, on the horizontal axis the caloric value of the combustible mixture is shown. This figure is schematic, because actual values depend on the dimensions and lay-out of the specific stove.

FIG. 3 shows a schematic representation of the relation between the preheat temperature and amount of enrichment required for a combustible gas of a given caloric value. On the vertical axis the degree of enrichment is shown, on the horizontal axis the preheat temperature is shown. This figure is schematic, because actual values depend on the dimensions and lay-out of the specific stove.

FIG. 4 schematically illustrates the definitions of regenerative heat exchanger efficiency and system efficiency. When evaluating a regenerative heat exchanger or a stove system, two definitions of efficiency are important. The most obvious definition is the efficiency of the stove, as this is the actual device used for the production of hot blast air, the boundaries of which are indicated schematically with the drawn line A. This is the efficiency the operator is familiar with. A second definition is the efficiency of the entire stove system including the preheating device or waste heat recovery unit and possibly other heat generators, the boundaries of which are indicated schematically with the dashed line B. When the stove system is regarded as a black box with only cold combustible gas (E), combustion air (F) and cold blast air (D) entering (including oxygen enrichment and steam injection), and hot blast air (G) and flue gases (C) leaving the system, the second definition for efficiency can be determined. It should be noted that this invention relates to increasing the efficiency of the stove system.

It is of course to be understood that the present invention is not in any way limited to the described embodiments and examples described above, but encompasses any and all embodiments within the scope of the description and the following claims.

1. Support assembly for supporting heat regeneration checker work in a hot blast stove for a blast furnace, the assembly comprising a supporting grid for supporting the checker work, and supporting columns for supporting the supporting grid, the assembly comprising a cast iron material, the cast iron material comprising a ferritic matrix and a dispersion of graphite particles wherein the shape of the graphite particles is substantially vermicular or nodular.

2. Support assembly according to claim 1, wherein the ratio between the length and the width of the graphite particles is substantially lower than 20.

3. Support assembly according to claim 1, wherein the cast iron material comprises (in weight percent):
2.0 to 3.8% carbon;
1.8 to 5.0% silicon;
0.1 to 1.0% manganese;
up to 0.1% phosphor;
up to 0.1% sulphur;
optionally up to 1.25% molybdenum;
unavoidable impurities, balance iron.

4. Support assembly according to claim 1, the cast iron material comprising a ferritic matrix and a graphite dispersion wherein the shape of the graphite is substantially nodular, wherein the ratio between the length and the width of the graphite particles is substantially lower than 5, wherein the cast iron material comprises (in weight percent):
2.0 to 3.8% carbon;
1.8 to 5.0% silicon;
0.1 to 1.0% manganese;
up to 0.1% phosphor;
up to 0.1% sulphur;
optionally up to 1.25% molybdenum;
unavoidable impurities, balance iron.

5. Support assembly according to claim 1, wherein the cast iron material comprises molybdenum between 0.1 and 1.25%.

6. Support assembly according to claim 1, wherein the cast iron material comprises silicon between 3.8 and 5.0.

7. Support assembly according to claim 1, wherein the cast iron material comprises carbon between 2.3 and 3.8.

8. Support assembly according to claim 1, wherein the cast iron material comprises manganese lower than 0.5%.

9. Regenerative heat generator, which generator comprises:
a combustion chamber and a heat-regeneration shaft filled with heat regeneration checker work, the combustion chamber and the heat regeneration shaft being separated by a wall, and
a burner being located at the bottom of the combustion chamber,
a connection port for supplying combustion air and
a connection port for supplying a combustible gas,
a discharge port for discharging the flue gas,
a cold blast inlet port for supplying cold blast air to be converted into hot blast air and
a discharge port for discharging the hot blast air,
the checker work in the heat regeneration shaft being supported by a support assembly comprising a supporting grid and supporting columns, wherein the support assembly is provided according to claim 1.

10. Method of producing hot blast air for a blast furnace using a hot blast stove, which stove is provided with a support assembly for supporting the checker work in the heat regeneration shaft according to claim 1.

11. Method of producing hot blast air for a blast furnace using a hot blast stove, which stove is provided with a support assembly for supporting the checker work in the heat regeneration shaft allowing a maximum flue gas temperature at the location of the support assembly of 500° C. or higher.

12. Support assembly according to claim 1, wherein the ratio between the length and the width of the graphite particles is substantially lower than 10.

13. Support assembly according to claim 1, wherein the ratio between the length and the width of the graphite particles is substantially lower than 8.

14. Support assembly according to claim 4, wherein the ratio between the length and the width of the graphite particles is substantially lower than 2.

15. Support assembly according to claim 4, wherein the ratio between the length and the width of the graphite particles is substantially lower than about 1.

16. Support assembly according to claim 1, wherein the cast iron material comprises molybdenum between 0.1 and 1.0%.

17. Support assembly according to claim 1, wherein the cast iron material comprises molybdenum between 0.3 and 0.9%.

18. Support assembly according to claim 1, wherein the cast iron material comprises silicon between 4.0 and 4.8%.

19. Support assembly according to claim 1, wherein the cast iron material comprises silicon between 4.3 and 4.8%.

20. Support assembly according to claim 1, wherein the cast iron material comprises carbon between 2.3 and 3.6%.

21. Support assembly according to claim 1, wherein the cast iron material comprises carbon between 2.4 and 3.3%.

22. Support assembly according to claim 1, wherein the cast iron material comprises manganese lower than 0.3%.

23. The regenerative heat generator according to claim 9, wherein the regenerative heat generator is a hot-blast stove for a blast furnace.

24. Method of producing hot blast air for a blast furnace using a hot blast stove, which stove is provided with a support assembly for supporting the checker work in the heat regeneration shaft allowing a maximum flue gas temperature at the location of the support assembly of 500° C. or higher, wherein the support assembly is a support assembly according to claim 1.
